(19) United States
(12) Patent Application Publication
(10) Pub. No.: US 2007/0289506 A1
(43) Pub. Date: Dec. 20, 2007

(54) TABLE

(76) Inventors: Paul Branch, Layton, UT (US); Katie Staples, Salt Lake City, UT (US); Ed VanNimwegen, North Ogden, UT (US); S. Curtis Nye, Clinton, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/762,712

(22) Filed: Jun. 13, 2007

Related U.S. Application Data
(63) Continuation-in-part of application No. 11/733,761, filed on Apr. 10, 2007.
(60) Provisional application No. 60/813,829, filed on Jun. 14, 2006.
(60) Provisional application No. 60/790,747, filed on Apr. 10, 2006.

(51) Int. Cl. A47B 9/06; B23P 11/00

(52) U.S. Cl. 108/116; 29/700

(57) ABSTRACT

A table may include a frame that is movable between an extended or use position and a collapsed or storage position. The table may also include a table top that is movable between an extended or use position and a collapsed or storage position. In addition, the table top may include one or more sections that may rotate, pivot, tilt and/or move into different positions. The table may further include a locking assembly that is sized and configured to lock the table top sections into one or more desired positions.

### CROSS-REFERENCE TO RELATED APPLICATIONS

This application claims priority to and the benefit of U.S. provisional patent application Ser. No. 60/813,829, which was filed on Jun. 14, 2006 and entitled LAPTOP TABLE.

This application is a continuation-in-part of U.S. patent application Ser. No. 11/733,761, which was filed Apr. 10, 2007 and entitled TABLE; which claims priority to and the benefit of U.S. provisional patent application Ser. No. 60/790,747, which was filed on Apr. 10, 2006 and entitled TABLE.

Each of these applications are incorporated by reference in their entireties.

### BACKGROUND OF THE INVENTION

1. Field of the Invention

The present invention generally relates to furniture and, in particular, to tables.

2. Description of Related Art

Conventional tables are used for a variety of purposes and come in a wide array of designs. In some situations, it is desirable to have a smaller table for personal or individual use. These smaller-sized tables intended for use by a single person may be referred to as a personal table. For example, persons living in a small space, such as a studio apartment, may choose to use a smaller or personal sized table on which to dine or perform tasks such as reading, working or writing. These smaller or personal sized tables can also be used to hold objects such as a computer.

Known tables often include a table top that is permanently fixed in a level orientation. Unfortunately, a level orientation may not be best suited for certain uses of the table. Known tables may also include a table top that is adjustable. Undesirably, adjusting the orientation of such table tops often requires the tightening and loosening of a knob or fastener, which can make adjusting the orientation of the table tops difficult, awkward and/or time consuming.

### BRIEF SUMMARY OF EMBODIMENTS OF THE INVENTION

A need therefore exists for a table that eliminates the above-described disadvantages and problems.

One aspect is a table including a table top. The table top may be movable between an extended or use position and a collapsed or storage position. The table may also include a frame that is sized and configured to support the table top, and the frame may be movable between an extended or use position and a collapsed or storage position. With the table top and the frame in a collapsed or storage position, the table may advantageously be relatively compact, which may allow the table to be stored in a smaller area. In addition, when in this relatively compact position, the table may be more efficiently shipped in smaller packaging.

Another aspect is a table that may include a table top and a frame which are separately movable between extended and collapsed positions. For example, when storage of the table is desired, the table top may be moved from an extended position to a collapsed position. If desired, the frame may also be moved from an extended position to a collapsed position. When use of the table is desired, the table top may be moved into the extended position. In addition, the frame may be moved to the extended position. The table top and frame may be sized and configured to be moved into the collapsed position before each other, after each other, or at the same time depending, for example, the particular configuration of the table. The table top and frame may further be sized and configured to be moved into the extended position before each other, after each other, or at the same time depending, for example, the particular configuration of the table. Advantageously, this may facilitate use of the table in many different environments and situations.

Still another aspect is a table that may include one or more wheels. The wheels may be sized and configured allow the table to be quickly and easily moved to a desired location. For example, the table may include a table top and/or frame that are movable between use and storage positions, and the wheels may be sized and configured to contact a support surface when the table top and/or frame are in the use positions. In addition, the wheels may be sized and configured to contact the support surface when the table top and/or frame are in the storage positions. The wheels may also be sized and configured to be spaced apart from the support surface when the table top and/or frame is in the use position or when the table is in the storage position depending, for example, upon the intended use of the table.

Yet another aspect is a table that may include a table top with a first table top section and a second table top section. The second table top section may be sized and configured to rotate, pivot, tilt and/or move relative to the first table top section, which may allow the table to accommodate a variety of users and be used for a number of different purposes. If desired, the second table top section may be sized and configured to rotate, pivot, tilt and/or move in one or more directions relative to the first table top section, including generally opposing directions.

A further aspect is a table that may include a table top with two or more movable sections. For example, the table may include a first table top section and a second table top section that is sized and configured to rotate, pivot, tilt and/or move between a first position in which the first and second table top sections are generally aligned and a second position in which the second table top section is positioned at an angle relative to the first table top section. Advantageously, when the second table top section is in the second position, the first and second table top sections may be positioned for different uses. For example, the first table top section could be positioned in a generally level position in which pencils, pens, rulers, books and/or other items may rest upon the first table top section, while the second table top section could be positioned to support a laptop computer in an ergonomically beneficial position. Of course, the table top sections may be positioned in other positions and the table may be used for a variety of other suitable purposes and functions.

A still further aspect is a table that may include a table top with two sections that are sized and configured to rotate, pivot, tilt and/or within a limited range of positions or angles. For instance, the second table top section may move within a limited range relative to the first table top section. Limiting the movement of the second table top section relative to the first table top section may advantageously ensure the table is used for its intended purpose. For example, the movement of the second table top section is preferably limited to about fifteen (15) degrees relative to the first table top section, which may help the second table top section support a laptop computer while creating an ergonomically beneficial position for the laptop. It will be appreciated, however, that the movement of the table top sections need not be limited to 15 degrees or any other angle. It will also be appreciated that the table top sections may be positioned at greater or lesser angles, if desired.

Yet another further aspect is a table that may include a table top with multiple sections that may be movable without requiring that a knob or fastener be loosened. For example, a first table top section may be sized and configured to rotate, pivot, tilt and/or move relative to a second table top section without tightening and loosening of a knob or fastener. In greater detail, the table top may include a ratcheting mechanism that is sized and configured to allow the position of a table top section to be incrementally adjusted without having to tighten and/or loosen a knob or fastener. The table may also include other portions, such as portions of the frame and/or the table top, which are connected in an adjustable manner. For instance, various components of the table may be connected by a friction, interference and/or snap fit, which may allow the position of the second table top section to be incrementally adjusted without having to tighten and/or loosen a knob or fastener.

Another aspect is a table that may include a table top which is movable between a plurality of heights. For example, the table top may be sized and configured to move between a first position in which the table top is positioned for use at a first height and a second position in which the table top is positioned for use at a second height.

Still another aspect is a table that may include a height adjustment mechanism that is sized and configured to adjust the height of the table top. The height adjustment mechanism is preferably sized and configured to be operated by a user with one hand or one foot. For example, the height adjustment mechanism may include a trigger (such as a button, lever, handle or the like) that may be operated with one hand to lock and/or unlock the table top at a height. Also, for example, the height adjustment mechanism may include a trigger (such as a foot pedal) that may be operated with one foot to lock and/or unlock the table top at a height.

Yet another aspect is a table that may include a height adjustment mechanism which is sized and configured to adjust the height of the table top in a generally smooth fashion. For example, the height adjustment mechanism may include a spring (such as a gas spring, a coiled spring or the like) which may advantageously help the height adjustment mechanism adjust the height of the table top in a generally smooth fashion.

A further aspect is a table that may be relatively small-sized and the table may be designed for use by a single person. This type of table that is intended for use by an individual may be referred to as a personal table, but it will be appreciated that more than one person could use the table if desired. Advantageously, the personal table may be relatively small and light-weight, which may make the table easy to move and transport. Significantly, because the table is sized and configured for personal use, it may not take up unnecessary space or provide a large amount of unused space. Therefore, the personal table may provide ample space for a single user without requiring a large area or wasting unnecessary space.

A still further aspect is a personal table that may be used for a wide variety of different situations and uses such as a table for supporting a television, computer, sewing machine, microwave, lamp, luggage, and the like. The table can also be used for a wide variety of other uses such as a bedside table, coffee table, night stand, desk, shop table, and the like. Further, the table can be used while performing a wide variety of tasks such as reading, writing, studying, working, etc. Thus, the personal table can be used in a number of different environments and it can perform numerous different tasks.

Another aspect is a table that may include a table top that is constructed from a lightweight material, which may allow the table to be easily portable and readily lifted by a single person. Desirably, the table top is constructed from blow-molded plastic, such as high density polyethylene. Advantageously, the blow-molded plastic table top may provide a rigid, high-strength structure that is capable of withstanding repeated use and wear. In addition, the blow-molded plastic table top may be easily manufactured and formed into the desired size and shape. The blow-molded plastic table top preferably includes a hollow interior portion that is formed during the blow-molding process, which may help the table top to be relatively lightweight.

Yet another aspect is a table that may include a table top and one or more legs that are offset towards one side of the table top. Advantageously, because the legs are not placed in the center of the table, that may provide enhanced legroom for the user. This may also allow the table top to be positioned closer to the body of the user, which may be more convenient for the user.

These and other aspects, features and advantages of the present invention will become more fully apparent from the following detailed description of preferred embodiments and appended claims.

### BRIEF DESCRIPTION OF THE DRAWINGS

The appended drawings contain figures of preferred embodiments to further illustrate and clarify the above and other aspects, advantages and features of the present invention. It will be appreciated that these drawings depict only preferred embodiments of the invention and are not intended to limit its scope. The invention will be described and explained with additional specificity and detail through the use of the accompanying drawings in which:

FIG. 1 is a top perspective view of an exemplary table, illustrating an table top and frame in extended or use positions;

FIG. 2 is a bottom perspective view of the table shown in FIG. 1;

FIG. 3 is a top perspective view of the table shown in FIG. 1, illustrating the table top in an extended or use position and a lower portion of the frame in a collapsed or storage position;

FIG. 4 is a bottom perspective view of the table shown in FIG. 3;

FIG. 5 is a top perspective view of the table shown in FIG. 1, illustrating the table top and the frame in a collapsed or storage position;

FIG. 6 is a bottom perspective view of the table shown in FIG. 5;

FIG. 7 is a right side view of the table shown in FIG. 5;

FIG. 8 is a left side view of the table shown in FIG. 5;

FIG. 9 is a perspective view of the table shown in FIG. 5;

FIG. 10 is a perspective view of the table shown in FIG. 1, illustrating the table top at a first height;

FIG. 11 is a perspective view of the table shown in FIG. 10, illustrating the table top at a different second height;

FIG. 12 is a top perspective view of the table shown in FIG. 1, illustrating a first table top section disposed in a first position and a second table top section disposed in a first position;

FIG. 13 is a bottom perspective view of the table shown in FIG. 12;

FIG. 14 is a left side view of the table shown in FIG. 12;

FIG. 15 is a top perspective view of the table shown in FIG. 12, illustrating the second table top section positioned at a second position;

FIG. 16 is a bottom perspective view of the table shown in FIG. 15;

FIG. 17 is a left side view of the table shown in FIG. 15;

FIG. 18 is an enlarged perspective view of a portion of the table shown in FIG. 1;

FIG. 19 is an enlarged perspective view of a portion of the table shown in FIG. 18;

FIG. 20 is a side perspective view of a portion of the table shown in FIG. 1;

FIG. 21 is an enlarged perspective view of a portion of the table shown in FIG. 20, illustrating an exemplary pin and an exemplary flange;

FIG. 22 is a perspective view of a portion of the table shown in FIG. 21, illustrating the position of the pin and flange when the table top sections are in the position shown in FIG. 12;

FIG. 23 is a perspective view of a portion of the table shown in FIG. 21, illustrating the position of the pin and flange when the table top sections are in the position shown in FIG. 15;

FIG. 24 is a perspective view of a portion of the table shown in FIG. 18;

FIG. 25 is a partially exploded view of the portion of the table shown in FIG. 24;

FIG. 26 is a partially exploded view of the portion of the table shown in FIG. 25;

FIG. 27 is a partially exploded view of the portion of the table shown in FIG. 26;

FIG. 28 is a partially exploded view of a portion of the table shown in FIG. 1, illustrating an exemplary wheel assembly; and

FIG. 29 is a partially exploded view of the wheel assembly shown in FIG. 28.

### DETAILED DESCRIPTION OF THE PREFERRED EMBODIMENTS

The present invention is generally directed towards a table. The principles of the present invention, however, are not limited to tables. It will be understood that, in light of the present disclosure, the table disclosed herein can be successfully used in connection with other types of furniture.

Additionally, to assist in the description of the table, words such as top, bottom, front, rear, right and left may be used to describe the accompanying figures, which are not necessarily drawn to scale. It will be appreciated, however, that the table can be located in a variety of desired positions—including various angles, sideways and even upside down. A detailed description of the table now follows.

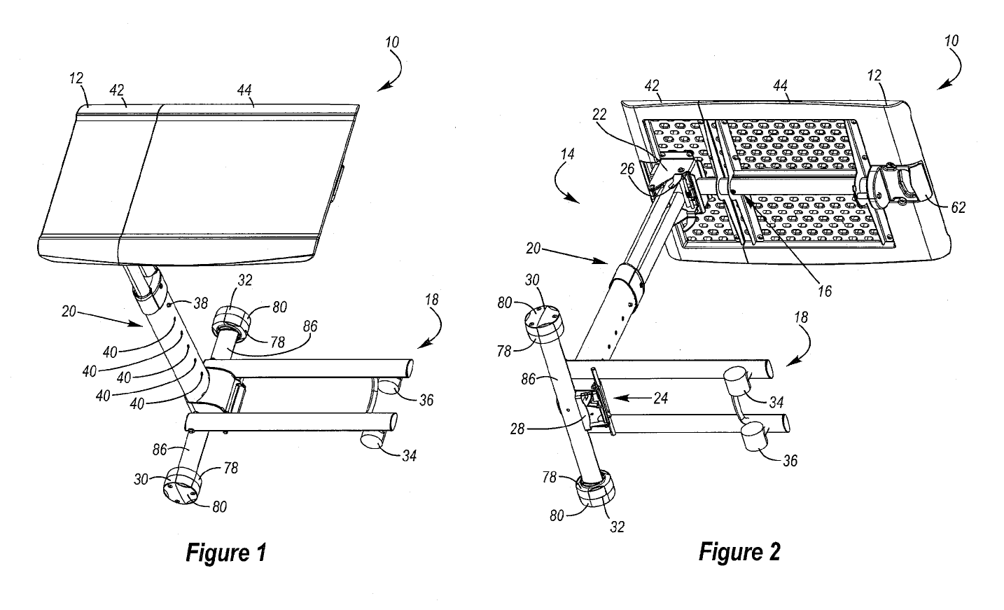

As shown in FIGS. 1-2, an exemplary table 10 may be a relatively small-sized table that is designed for use by a single person. This type of table that is intended for use by an individual may be referred to as a personal table, but it will be appreciated that more than one person could use the table 10 if desired. Advantageously, the personal table 10 may be relatively small and light-weight, which may make the table easy to move and transport. Significantly, because the table 10 may be sized and configured for personal use, it may not take up unnecessary space or provide a large amount of unused space. Therefore, the personal table 10 may provide ample space for a single user without requiring a large area or wasting unnecessary space. In addition, the personal table 10 can be used for a wide variety of different situations and uses such as a table for supporting a television, computer, sewing machine, microwave, lamp, luggage, and the like. The table 10 can also be used for a wide variety of other uses such as a bedside table, coffee table, night stand, desk, shop table, and the like. Further, the table 10 can be used while performing a wide variety of tasks such as reading, writing, studying, working, etc. Thus, the personal table 10 can be used in a number of different environments and it can perform numerous different tasks. It will be appreciated, however, that the table 10 need not be a personal table and that the table may have a variety of other suitable sizes and configurations.

As shown in FIGS. 1-2, the table 10 may include a table top 12. The table top 12 may be constructed from a lightweight material so that the table 10 is easily portable and can be readily lifted and moved by a single person. Desirably, the table top 12 is constructed from blow-molded plastic, such as high density polyethylene. The blow-molded plastic table top 12 may provide a rigid, high-strength structure that is capable of withstanding repeated use and wear. Advantageously, the blow-molded table top can be easily manufactured and formed into the desired size and shape. The blow-molded plastic table top 12 preferably includes a hollow interior portion, which may be formed during the blow-molding process, and that may result in a relatively lightweight table top. It will be appreciated, however, that the table top 12 may be constructed using other suitable materials and/or other processes.

The table 10 may also include a frame 14 that is sized and configured to support the table top 12. The frame 14 may include an upper portion 16, a lower portion 18 and an intermediate portion 20 extending between the upper and lower portions of the frame. The frame 14 and its components are preferably at least partially constructed from metal, such as steel. It will be appreciated, however, that the frame 14 and its components may be constructed from other suitable materials.

The intermediate portion 20 of the frame may include one or more legs and the lets may be offset towards one side of the table top 12. Advantageously, if the legs are not placed in the center of the table 10, then that may provide enhanced legroom for the user. This may also allow the table top 12 to be positioned closer to the body of the user, which may be more convenient for the user. It will be appreciated, however, that the legs and the intermediate portion 20 need not be offset towards one side of the table top 12 and may be positioned in any desired location.

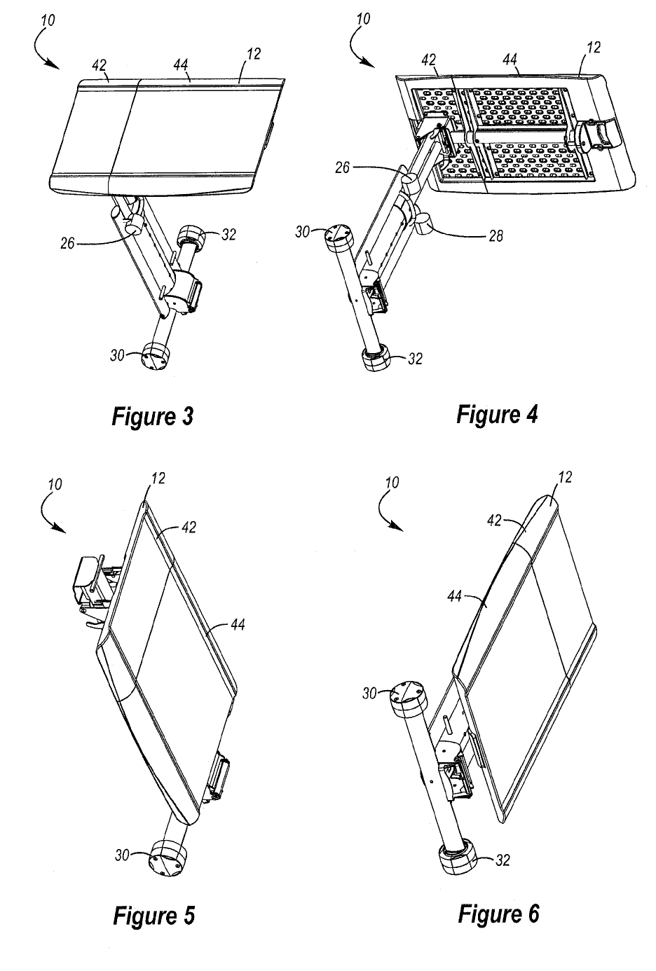

As shown in FIGS. 3-6, the table top 12 and the frame 14 may be movable between an extended or use position and a collapsed or storage position. With the table top 12 and the frame 14 in a collapsed or storage position, the table 10 may advantageously be relatively compact, which may allow the table to be stored in a smaller area. In addition, when in this relatively compact position, the table 10 may be more efficiently shipped in smaller packaging.

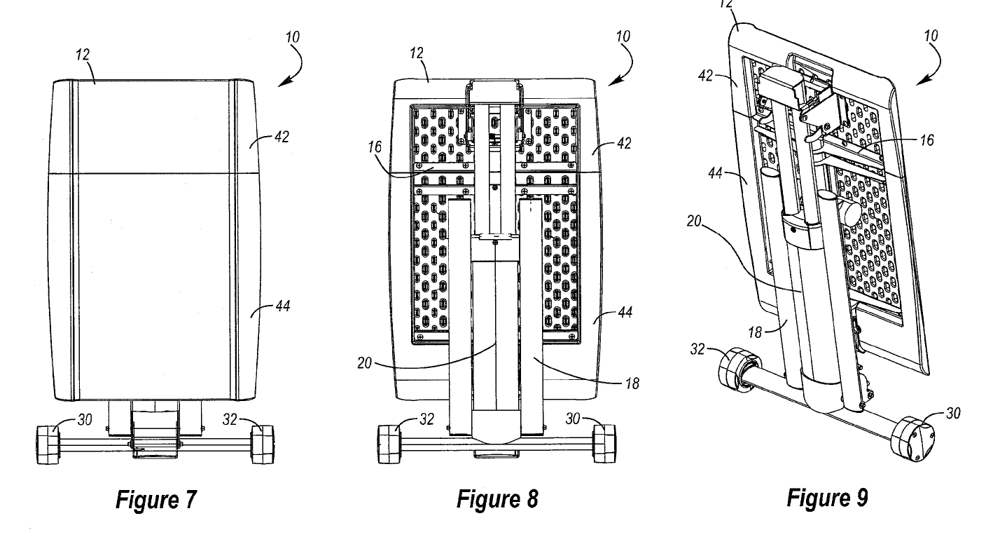

In further detail, when storage of the table 10 is desired, the lower portion 18 of the frame 14 may be moved from the extended position shown in FIGS. 1-2 to the collapsed position shown in FIGS. 3-4, and then the table top 12 and the upper portion 16 of the frame may be moved from the extended positions shown in FIGS. 3-4 to the collapsed positions shown in FIGS. 5-9. When use of the table 10 is desired, the table top 12 and the upper portion 16 of the frame 14 may be moved to back to their extended positions, and then the lower portion 18 of the frame may be moved back to its extended position.

In another instance, when storage of the table 10 is desired, the table top 12 and the upper portion 16 of the frame 14 may be moved from the extended positions to the collapsed positions, and then the lower portion 18 of the frame may be moved from the extended position to the collapsed position. In this instance, when use of the table 10 is desired, the lower portion 18 of the frame 14 may be moved to back to its extended position, and then the table top 12 and the upper portion 16 of the frame may be moved back to their extended positions.

To facilitate the movement of the table top 12 and the frame 14 between the extended and collapsed positions, the portions 16, 18, 20 of the frame may be pivotally or otherwise movably interconnected. For example, an upper part of the intermediate portion 20 may be pivotally or otherwise movably connected to the upper portion 16 of the frame 14, and a lower part of the intermediate portion may be pivotally or otherwise movably connected to the lower portion 18 of the frame. The portions 16, 18, 20 of the frame 14 may be pivotally or otherwise movably interconnected using one or more brackets, connectors, fasteners, hinges, locking assemblies and/or the like.

If desired, some or all of the components of the table top 12 and the frame 14 may be separately movable between the extended and collapsed positions. In addition, some or all of the components of the table top 12 and the frame 14 may be sized and configured to be collapsed before each other, after each other, or at the same time depending, for example, the particular configuration of the table 10. It will be appreciated that the components of the table top 12 and the frame 14 need not be separately movable between the extended and collapsed positions.

As shown in FIGS. 1-2, the table top 12 and the upper and lower portions 16, 18 of the frame 14 may be aligned in generally parallel planes when the table top and the frame are in the extended positions. In addition, when the table top 12 and the frame 14 are in the extended positions, the intermediate portion 20 may be in a generally perpendicular orientation relative to the table top and/or the upper and lower portions 16, 18 of the frame.

As shown in FIGS. 5-9, the table top 12 and the upper, lower and intermediate portions 16, 18, 20 of the frame 14 may be aligned in generally parallel planes when the table top and the frame are in the collapsed positions. This may advantageously allow the table 10 to be stored in a smaller area and/or to be more efficiently shipped in smaller packaging. It will be appreciated, however, that the table top 12 and the upper, lower and intermediate portions 16, 18, 20 of the frame 14 may be disposed in other suitable relative positions when the table top and the frame are in a collapsed position.

Desirably, some or all of the components of the table top 12 and the frame 14 may be locked in the extended positions. For example, as shown in FIG. 2, the table 10 may include a first locking assembly 22 and a second locking assembly 24. The first locking assembly 22 may be sized and configured to lock the table top 12 and the upper portion 16 of the frame 14 in the extended positions, and the second locking assembly 24 may be sized and configured to lock the lower portion 18 of the frame in the extended position. The locking assemblies 22, 24 are preferably sized and configured to automatically lock the table top 12, the upper portion 16 and the lower portion 18 in the extended positions. The locking assemblies 22, 24 may include a trigger 26, 28 (such as a button, lever, handle or the like) that may be used to unlock the locking assemblies to permit the table top 12 and upper and lower portions 16, 18 to be moved from the extended positions to the collapsed positions. It will be appreciated, however, that the locking assemblies 22, 24 need not be automatically locking and the triggers 26, 28 may be used to manually lock the locking assemblies. It will also be appreciated that the table 10 does not require the locking assemblies 22, 24 and/or the triggers 26, 28.

The table 10 may also include wheels 30, 32, 34, 36, which may be sized and configured allow the table to be quickly and easily moved to a desired location. The wheels 30, 32, 34, 36 may be sized and configured to contact a support surface when the table 10 is in the extended or use position, for example, as shown in FIGS. 1-2. In addition, when the table 10 is in the collapsed or storage position, the wheels 30, 32 may contact the support surface while the wheels 34, 36 are spaced apart from the support surface, for example, as shown in FIGS. 5-9. The wheels 30, 32, however, may be spaced apart from the support surface when the table 10 is in the use position or when the table is in the collapsed position depending, for example, upon the particular configuration and/or intended use of the table 10.

If desired, one or more of the wheels 30, 32, 34, 36 may be connected to the frame 14. For example, wheels may be connected to the lower portion 18 of the frame and/or the intermediate portion 20 of the frame. It will be appreciated, however, that the wheels 30, 32, 34, 36 may be connected to other suitable portions of the table 10 and that the table 10 does not require any wheels.

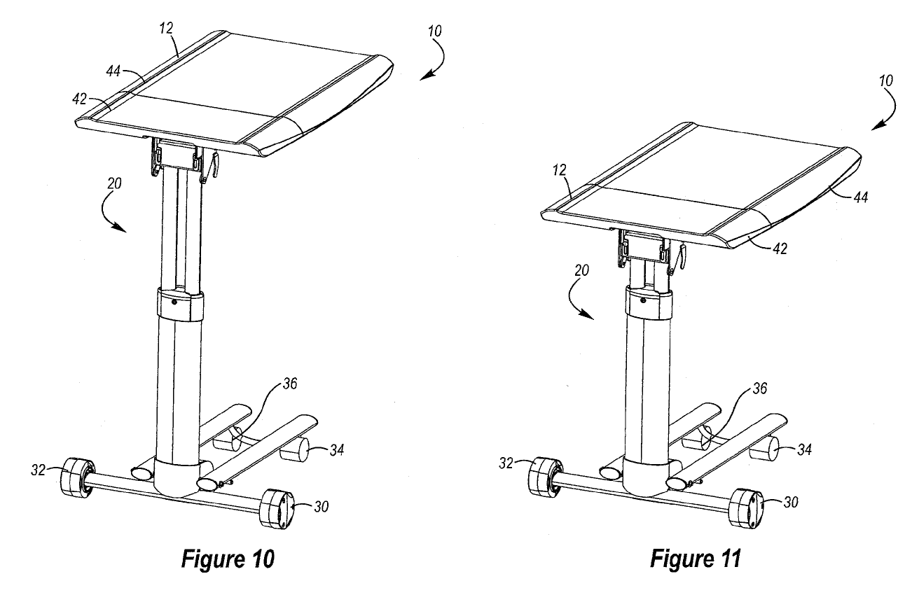

As shown in FIGS. 10-11, the table top 12 may be sized and configured to be moved between a plurality of different heights. For example, the table top 12 may be sized and configured to move between a first position in which the table top is positioned for use at a first height and a second position in which the table top is positioned for use at a second height.

In further detail, the table 10 may include a height adjustment mechanism that is sized and configured to adjust the height of the table top 12. In particular, the height adjustment mechanism may increase the length of the intermediate portion 20 to raise the table top 12 or may decrease the length of the intermediate portion to lower the table top. The height adjustment mechanism may advantageously be sized and configured to adjust the height of the table top 12 in a generally smooth fashion. For example, the height adjustment mechanism may include a spring (such as a gas spring, a coiled spring or the like) which may advantageously help adjust the length of the intermediate portion 20, and thus also the height of the table top 12, in a generally smooth fashion.

The height adjustment mechanism may be sized and configured to be operated by a foot or hand of the user. For example, the height adjustment mechanism may include a trigger (such as a foot pedal) that may be operated with one foot to lock and/or unlock the table top 12 at a given height. Also, for example, height adjustment mechanism may include a trigger (such as a button, lever, handle or the like) that may be operated with one hand to lock and/or unlock the table top at a particular height. In addition, the hand-operated trigger may be sized and configured to be grasped in order to help lift or lower the table top 12.

As shown in FIG. 1, the height adjustment mechanism may include a push button 38. The push button 38, for example, may engage any plurality of openings 40 in the intermediate portion 20 of the frame 14 to help lock the table top 12 at a desired height. It will be appreciated, however, that the height adjustment mechanism does not require a push button 38, openings 40, triggers or springs and the height adjustment mechanism may include a variety of other suitable structures and components. It will also be appreciated that the height adjustment mechanism may have a variety of suitable shapes, sizes, configurations and arrangements depending, for example, upon the intended use of the table 10, but the height adjustment mechanism is not required.

As shown in FIGS. 1-2, the table top 12 may include a plurality of sections, such as a first table top section 42 and a second table top section 44. The table top sections 42, 44 may be sized and configured to move between one or more positions. For example, the second table top section 44 may be sized and configured to rotate, pivot, tilt and/or move relative to the first table top section 42. The first and second table top sections 42, 44 may also be sized and configured to rotate, pivot, tilt and/or move in one or more directions, including generally opposing directions. Advantageously, this may allow the table 10 to be used by a number of people and used for a variety of different purposes and functions.

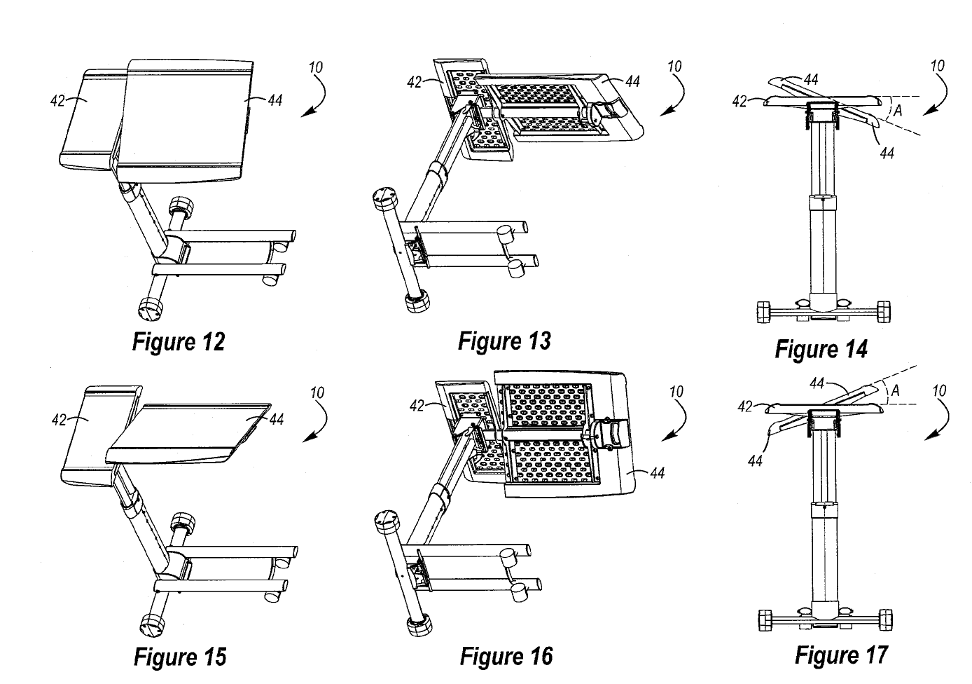

In greater detail, the table top section 44 may be sized and configured to rotate, pivot, tilt and/or move between a first position in which the first and second table top sections are generally aligned (for example, as shown in FIGS. 1-2) and a second position in which the second table top section is positioned at an angle relative to the first table top section (for example, as shown in FIGS. 12-14 or as shown in FIGS. 15-17). Advantageously, when the second table top section 44 is in the second position, the table top sections 42, 44 may be positioned for different uses. For example, the first table top section 42 could be positioned in a generally level position in which pencils, pens, rulers, books and/or other items may rest upon the first table top section, while the second table top section 44 could be positioned to support a laptop computer in an ergonomically beneficial position. Of course, the first and second table top sections 42, 44 may be disposed in other positions and the table top sections may be used for a variety of suitable purposes and functions.

Additionally, the movement of the first and second table top sections 42, 44 may be limited. For example, the first table top section 42 may be disposed in a generally fixed location when the table 10 is in the use position. The first table top section 42, however, could move in one or more directions. For example, the first table top section 42 could move upwardly or downwardly if the upper portion 16 of the frame 14 is moved. In addition, the first table top section 42 could move side-to-side, if desired. The second table top section 44 may be sized and configured to rotate, pivot, tilt and/or move within a limited range relative to the first table top section 42. Limiting the movement of the second table top section 44 relative to the first table top section 42 may advantageously help ensure that the table 10 is used for its intended purposes or functions. For example, as shown in FIGS. 14 and 17, the movement of the second table top section 44 is preferably limited to an angle A of about fifteen degrees (15°) relative to the first table top section 42, which may allow the second table top section to support a laptop computer in a desired ergonomic position.

The movement of the second table top section 44 may be limited to a larger or smaller amount, if desired. For example, the angle A may be limited to about five, ten, twenty, twenty-five, thirty or more degrees relative to the first table top section 42 depending, for example, upon the intended use of the second table top section 44. Additionally, the second table top section 44 may be sized and configured to move forwardly and backwardly. For instance, where the second table top 44 is sized and configured to rotate, pivot, tilt and/or move in different directions, the movement of the table top section 44 may be limited to a range of angles between plus or minus about ten degrees, plus or minus about fifteen degrees, plus or minus about twenty degrees, plus or minus about twenty-five degrees, plus or minus about thirty degrees, or other suitable angles. It will be appreciated that the first and second table top sections 42, 44 may move any desired amounts and the movement of the table top sections does not have to be limited.

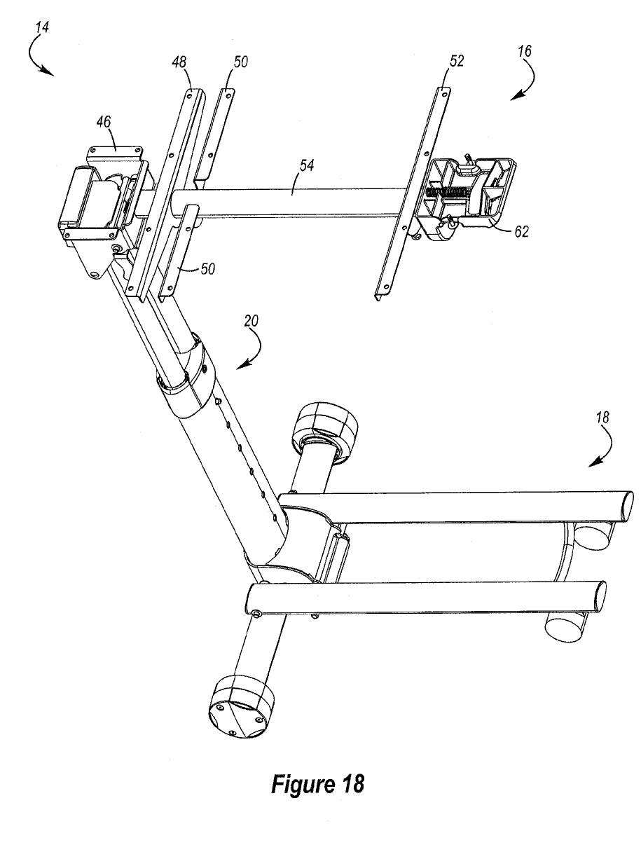

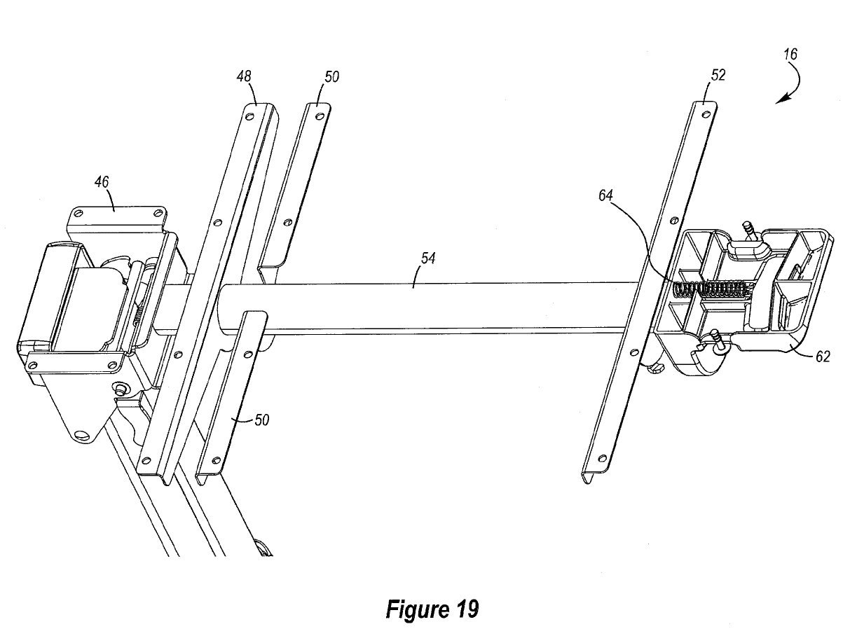

The frame 14 may be sized and configured to facilitate the movement of the first and second table top sections 42, 44. For example, the upper portion 16 of the frame 14 may include supports, such as brackets, tubes, rods and the like. The supports may be connected to the table top sections 42, 44, and the supports may be movable relative to each other to facilitate the movement of the second table top section 44 relative to the first table top section 42. In further detail, as shown in FIGS. 18-19, the upper portion 16 of the frame 14 may include a first set of supports 46, 48 and a second set of supports 50, 52, and the first and second sets of supports may be connected to the first and second table top sections 42, 44, respectively. The upper portion 16 of the frame 14 may also include an elongated member 54, such as a tube, rod or the like. The second table top section 44 and the supports 50, 52 may be pivotally, rotatably and/or movably connected to the elongated member 54, which may allow the second table top section and the supports 50, 52 to pivot, rotate, tilt and/or move relative to the first table top section 42 and the supports 46, 48. It will be appreciated, however, that the frame 14 does not require the supports 46, 48, 50, 52 or the elongated member 54 and that the frame may have other suitable shapes, sizes, configurations and arrangements to facilitate the movement of the first and/or second table top sections 42, 44.

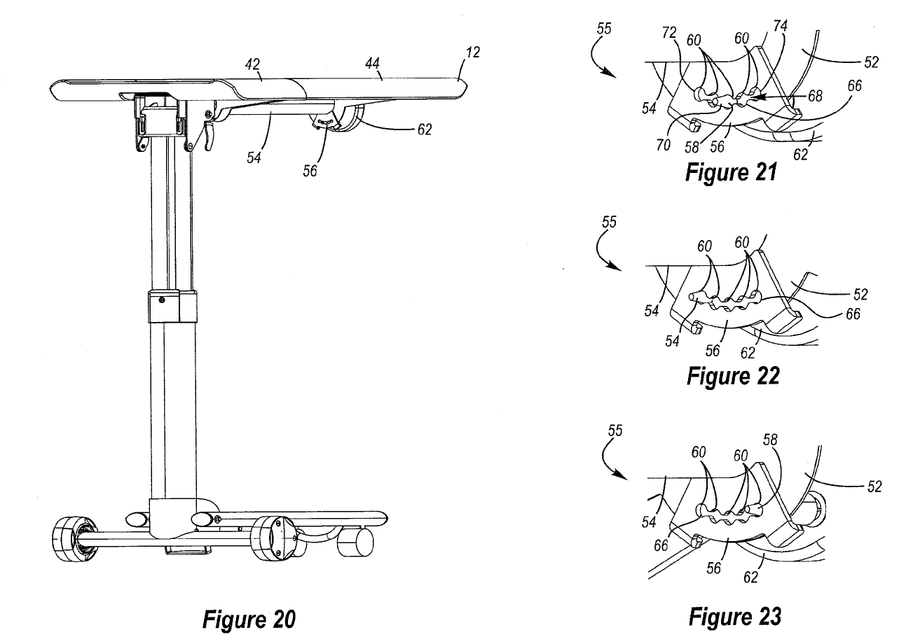

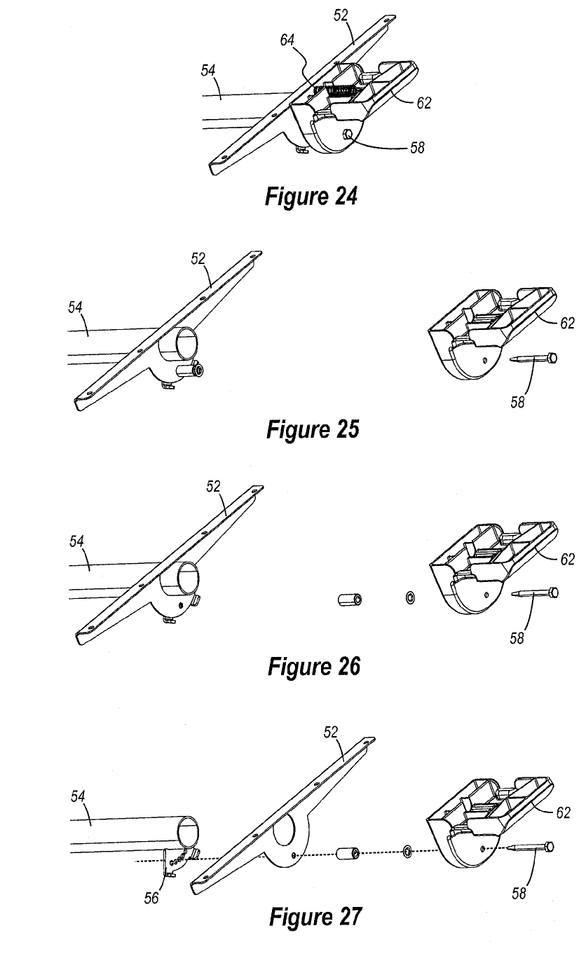

The first table top section 42 may be held in a generally fixed position when the table 10 is in the use position and the movement of the second table top section 44 relative to the first table top section may be limited. For example, as shown in FIGS. 20-23, the table 10 may include a locking assembly 55 that may be sized and configured to secure the second table top section 44 in a desired position relative to the first table top section 42 and/or limit the movement of the second table top section within a given range relative to the first table top section 42. In particular, the locking assembly 55 may include a flange 56 and a pin 58. The flange 56 may be sized and configured to engage the pin 58 to secure the second table top section 44 in a desired position relative to the first table top section 42. In addition, the flange 56 may be sized and configured to engage the pin 58 to limit the movement of the second table top section 44 relative to the first table top section 42.

In further detail, the flange 56 may include a plurality of receiving portions 60 that are sized and configured to engage the pin 58 using, for example, a snap fit, a friction fit and/or an interference fit. This may advantageously limit the relative movement of the flange 56 and the pin 58. This may also limit the relative movement of the first and second table top sections 42, 44 because the flange 56 may be secured to first table top section 42 and the pin 58 may be secured to the second table top section 44. For example, the flange 56 may be connected to the pivot 54, which may be connected to the first table top section 42 by the brackets 46, 48; and the pin 58 may be connected to a handle 62, which may be connected to the second table top section 44.

The handle 62 may be used to move the pin 58 among a variety of positions to help facilitate movement of the second table top section 44 from a first position relative to the first table top section 42 to a second position relative to the first table top section. In particular, the pin 58 may initially engage a first receiving portion 60, which may lock the second table top section 44 at the first position. When it is desired to move the second table top section 44, the handle 62 may be used to pull the pin 58 in a direction away from the flange 56, which may cause the pin to disengage the first receiving portion 60. With the pin 58 disengaged from the first receiving portion 60, the second table top section 44 may be pivoted, rotated, tilted and/or moved from the first position to the second position. With the second table top section 44 in the second position, the handle 62 may be used to push the pin 58 in a direction towards the flange 56, causing the pin to engage a second receiving portion 60 to lock the second table top section in the second position.

As shown in FIG. 19, the locking assembly 55 may include a biasing member 64, such as a spring. The biasing member 64 may be sized and configured to bias the pin 58 in a direction towards a locked position in which the pin engages the flange 56 and away from an unlocked position in which the pin is disengaged from the flange. In particular, the biasing member 64 may be sized and configured to bias the handle 62 in a direction towards the flange 56 and, thus, to bias the pin 58 in a direction towards a locked position in which the pin engages one of the receiving portions 60. For example, the biasing member 64 may be sandwiched between a portion of the handle 62 and a portion of the second table top section 44. When the handle 62 pulls the pin 58 away from a locked position to an unlocked position, the biasing member 64 may be compressed between the portions of the handle and the second table top section 44. When the handle 62 is released, the biasing member 64 may resiliently decompress, exerting a force against portions of the handle and the second table top section 44, which may cause the handle to automatically bias the pin 58 back to a locked position.

As shown in FIGS. 21-23, the receiving portions 60 may be formed as part of a single, unitary opening or recess 66. This may allow the pin 58 to move among the various receiving portions 60, while at least a portion of the pin remains in the opening 66. In particular, the opening 66 may include narrowed passageways 68, which may join adjacent receiving portions 60. Desirably, a portion of the pin 58 may be sized and configured to pass through the narrowed passageways 68 when the pin is in an unlocked position. For example, an end 70 of the pin 58 may have a generally tapered configuration, and a narrower portion of the generally tapered end may be sized and configured to pass through the narrowed passageways 68 when the pin is in an unlocked position. This may allow a portion of the pin 58 to remain in the opening 66, while the position of the second table top section 44 to be adjusted.

Because a portion of the pin 58 may remain in the opening 66, the portion of the pin may eventually contact, abut and/or engage the ends 72, 74 of the opening when the second table top section 44 reaches particular positions relative to the first table top section 42. Advantageously, this may limit the movement of the second table top section 44. For example, as shown in FIG. 22, the pin 58 may contact, abut and/or engage the end 72 of the opening 66 when the second table top section 44 reaches the position shown in FIG. 12. Likewise, as shown in FIG. 23, the pin 58 may contact, abut and/or engage the end 74 when the second table top section 44 reaches the position shown in FIG. 15. Thus, the opening 66 may advantageously be sized and configured to limit the movement of the second table top section 44 to a limited range relative to the first table top section 42, as discussed above. It will be appreciated, however, that the receiving portions 60 need not be formed as part of a unitary, one-piece opening or structure, and that some or all of the receiving portions may be formed as discrete openings or recesses, and it could have other suitable shapes, sizes, configurations and arrangements.

As shown above, the second table top section 44 may be locked and unlocked in various positions without tightening and loosening of a knob or fastener. In particular, one or more portions of the locking assembly 55 and/or other components of the table 10 may be connected with a friction fit, an interference fit and/or a snap fit, and that may allow the position of the second table top section 44 to be incrementally adjusted without having to tighten and/or loosen a knob or fastener. It will be appreciated, however, that the table 10 may include in other features that may allow the second table top section 44 to be locked and unlocked in various positions without the tightening and loosening of a knob or fastener. For example, the table 10 may include a ratcheting mechanism that is sized and configured to allow the position of the second table top section 44 to be incrementally adjusted without tightening and/or loosening a knob or fastener. It will be appreciated, however, that the tightening and loosening of a knob or fastener may be used to lock and unlock the second table top section 44, if desired.

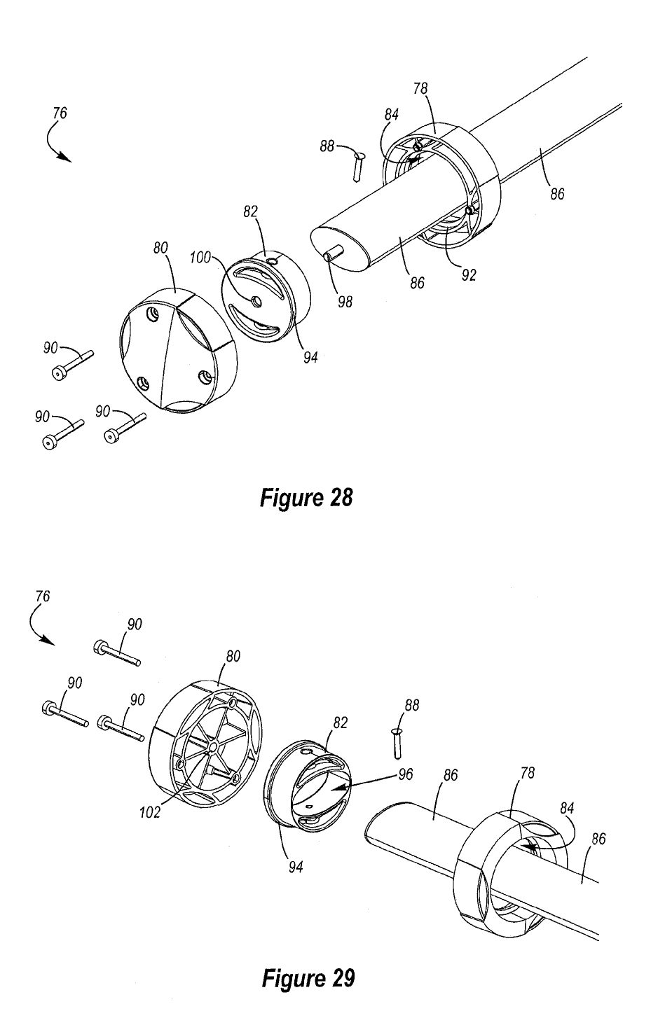

As shown in FIGS. 28-29, the table 10 may include a wheel assembly 76 with a first wheel section 78, a second wheel section 80 and a hub 82. The first wheel section 78 may include an opening 84 through which a support member 86, such as an axle, may extend. With the support member 86 extending through the opening 84 in the first wheel section 78, the hub 82 may be connected to the support member using one or more fasteners 88 and then the wheel sections 80, 82 may be interconnected using one or more fasteners 90.

Desirably, the wheel sections 78, 80 and the hub 82 may be connected to an end of the support member 86, which may eliminate any need for a cap or cover for the end of the support member 86. It will be appreciated, however, that the hub 82 may be connected to other portions of the support member 86. It will also be appreciated that the wheel sections 80, 82 and/or the hub 82 and the support member 86 may be interconnected using one or more fasteners; a snap fit, a friction fit, and/or an interference fit; one or more adhesives and/or any other suitable means.

As shown in FIG. 28, one or both of the wheel sections 78, 80 may form at least a part of a receiving portion 92, which may receive at least a portion of the hub 82. In particular, the receiving portion 92 may be sized and configured to receive and rotatably couple a ridge 94 formed in the hub 82, which may allow the wheel sections 78, 80 to rotate about the hub. In addition, the ridge 94 may be positioned between the wheel sections 78, 80, which may desirably limit the wheel sections' movement along the length of the support member 86.

As shown in FIG. 29, the hub 82 may include a receiving portion 96 that may be sized and configured to receive and/or retain at least a portion of the support member 86. In particular, the support member 86 may have a non-circular cross section and the receiving portion 96 of the hub 82 may have a complementary non-circular cross section that is sized and configured to engage the support member using a snap fit, a friction fit and/or an interference fit. For example, the support member 86 may have a generally oblong configuration and the receiving portion 96 of the hub 82 may have a generally oblong configuration. Desirably, this may help prevent the hub 82 from rotating relative to the support member 86. Moreover, this may allow the wheel assembly 76 to be used in connection with a generally oblong support member 86. It will be appreciated, however, that the support member 86 and the receiving portion 96 may have any other suitable shape and/or configuration.

As shown in FIG. 28, the support member 86 may be connected to a pin 98. The pin 98 may extend through an opening 100 in the hub 82 and into a receiving portion 102 formed in the wheel section 80. Desirably, the pin 98 may help provide additional support for the hub 82 and/or the wheel section 80. As best seen in FIGS. 1-2, the wheel sections 78, 80 may help hide the attachment of the hub 82 to the support member 86. This may advantageously help provide a cleaner, more appealing visual appearance. It will be appreciated that the table 10 may include wheels attached to other suitable portions of the frame 14 and the wheels may have various shapes, sizes, configurations and arrangements depending, for example, upon the intended use of the table.

Although this invention has been described in terms of certain preferred embodiments, other embodiments apparent to those of ordinary skill in the art are also within the scope of this invention. Accordingly, the scope of the invention is intended to be defined only by the claims which follow.

What is claimed is:

1. A method for using a table, the table comprising a table top and a frame connected to the table top, the table top comprising a first table top section and a second table top section, the method comprising:
moving the table top and the frame from a collapsed position to an extended position, the frame including an upper portion, a lower portion and an intermediate portion, the intermediate portion being generally perpendicular to the upper and lower portions when the table top and the frame are in the extended position, the upper, lower and intermediate portions being generally aligned when the table top and the frame are in the collapsed position; and
while the table top and the frame are in the extended position, moving the second table top section among a plurality of angles relative to the first table top section.

2. The method as in claim 1, further comprising locking the second table top section at an angle relative to the first table top section.

3. The method as in claim 2, further comprising unlocking the second table top section.

4. The method as in claim 1, wherein the moving the table top and the frame from a collapsed position to an extended position comprises:
moving the table top and the upper portion of the frame from a collapsed position to an extended position; and
moving the lower portion of the frame from a collapsed position to an extended position.

5. The method as in claim 4, wherein at least a portion of the moving the table top and the upper portion of the frame from a collapsed position to an extended position is performed before the moving the lower portion of the frame from a collapsed position to an extended position.

6. The method as in claim 4, wherein at least a portion of the moving the table top and the upper portion of the frame from a collapsed position to an extended position is performed after the moving the lower portion of the frame from a collapsed position to an extended position.

7. The method as in claim 4, wherein at least a portion of the moving the table top and the upper portion of the frame from a collapsed position to an extended position is performed at the same time as at least a portion of the moving the lower portion of the frame from a collapsed position to an extended position.

8. The method as in claim 1, wherein the moving the table top and the frame from a collapsed position to an extended position comprises:
pivoting the table top and the upper portion of the frame from a collapsed position to an extended position; and
pivoting the lower portion of the frame from a collapsed position to an extended position.

9. The method as in claim 8, wherein at least a portion of the pivoting the table top and the upper portion of the frame from a collapsed position to an extended position is performed before the pivoting the lower portion of the frame from a collapsed position to an extended position.

10. The method as in claim 8, wherein at least a portion of the pivoting the table top and the upper portion of the frame from a collapsed position to an extended position is performed after the pivoting the lower portion of the frame from a collapsed position to an extended position.

11. The method as in claim 8, wherein at least a portion of the pivoting the table top and the upper portion of the frame from a collapsed position to an extended position is performed at the same time as at least a portion of the pivoting the lower portion of the frame from a collapsed position to an extended position.

12. A method for using a table; the table comprising a table top and a frame connected to the table top, the table top comprising a first table top section and a second table top section, the method comprising:
moving the table top and the frame from a collapsed position to an extended position, the frame including an upper portion, a lower portion and an intermediate portion, the intermediate portion being generally perpendicular to the upper and lower portions when the table top and the frame are in the extended position, the upper, lower and intermediate portions being generally aligned when the table top and the frame are in the collapsed position; and
while the table top and the frame are in the extended position, pivoting the second table top section among a plurality of positions relative to the first table top section.

13. The method as in claim 12, wherein the moving the table top and the frame from a collapsed position to an extended position comprises:
moving the table top and the upper portion of the frame from a collapsed position to an extended position; and
moving the lower portion of the frame from a collapsed position to an extended position.

14. The method as in claim 12, wherein the moving the table top and the frame from a collapsed position to an extended position comprises:
pivoting the table top and the upper portion of the frame from a collapsed position to an extended position; and
pivoting the lower portion of the frame from a collapsed position to an extended position.

15. The method as in claim 12, wherein table further comprises a wheel assembly comprising:
a hub connected to the frame;
a first wheel section; and
a second wheel section sized and configured to be connected to the first wheel section with at least a portion of the hub positioned between the first and second wheel sections, the first and second wheel sections being sized and configured to engage a support surface when the frame and the table top are in the extended position and when the frame and table top are in the collapsed position.

16. A method for assembling at least a portion of a table, the method comprising:
inserting a portion of a support member of a frame of a table through an opening in a first wheel section;
connecting a hub to an end of the support member; and
connecting the first wheel section to a second wheel section, a portion of the hub being disposed within a receiving portion defined by at least one of the first wheel section and the second wheel section.

17. The method as in claim 16, wherein the hub includes a ridge and the receiving portion is sized and configured to receive at least a portion of the ridge.

18. The method as in claim 16, wherein the support member has a non-circular cross section; and wherein the hub has a non-circular receiving portion sized and configured to receive and engage a portion of the support member.
